(19) United States
(12) Patent Application Publication
(10) Pub. No.: US 2006/0118573 A1
(43) Pub. Date: Jun. 8, 2006

(54) Automated small item dispense module

(76) Inventors: Brian L. Ganz, Carlsbad, CA (US); John A. Adams, Escondido, CA (US); John Hoffman, Poway, CA (US); John Andrew Moulds, Encinitas, CA (US); Thomas E. Vorndran, Oceanside, CA (US)

Correspondence Address: John R. Ross, III;Ross Patent Law Office, P.O. Box 2138, Del Mar, CA, 92014, US

(21) Appl. No.: 10/980,008

(22) Filed: Nov. 3, 2004

(51) Int. Cl. A24F 15/04; G07F 11/16

(52) U.S. Cl. 221/254

(57) ABSTRACT

A small item dispense module. Small items are stored inside a first chamber. The small items are then transferred to a second chamber having a first singulator. The first singulator transfers the small items to a third chamber having a second singulator. The second singulator transfers the small items from the third chamber to a discharge tube having a discharge gate. The discharge gate allows for the dispensing of the small items so that they easily accessible. Preferably, the dispense module further includes: a microcontroller with real-time clock, a unique electronic identification number, an external barcode identification label, and an automatic locking mechanism that can be released electronically and controlled by the microcontroller. The microcontroller also preferably keeps track of dispense and fill requests and inventory. In a preferred embodiment, the small items being dispensed are pills.

The present invention relates to small item dispensing and singulating devices, and in particular, to automated small item dispensing and singulating devices.

### BACKGROUND OF THE INVENTION

Devices for automatically counting and dispensing small objects (such as coins, pills and gemstones) are known in the prior art. However, many of these devices tend to be expensive, complicated and susceptible to error. Senior citizens on a limited budget are usually not able to afford expensive prior art automatic pill dispensing devices. Also, an error in dispensing a requested amount of small items can have significant consequences. For example, if the items being dispensed are pills, an incorrect number can affect the health of the taker of the medication.

What is needed is an inexpensive and accurate device for counting and dispensing small objects.

### SUMMARY OF THE INVENTION

The present invention provides a small item dispense module. Small items are stored inside a first chamber. The small items are then transferred to a second chamber having a first singulator. The first singulator transfers the small items to a third chamber having a second singulator. The second singulator transfers the small items from the third chamber to a discharge tube having a discharge gate. The discharge gate allows for the dispensing of the small items so that they easily accessible. Preferably, the dispense module further includes: a microcontroller with real-time clock, a unique electronic identification number, an external barcode identification label, and an automatic locking mechanism that can be released electronically and controlled by the microcontroller. The microcontroller also preferably keeps track of dispense and fill requests and inventory. In a preferred embodiment, the small items being dispensed are pills.

### BRIEF DESCRIPTION OF THE DRAWINGS

FIG. 1 is a side view of a preferred embodiment of the present invention

FIG. 1A shows a preferred agitator.

FIG. 1B shows a front view of a preferred singulator.

FIG. 2 shows a perspective view of a preferred singulator.

FIG. 3 shows connectivity to a computer network.

FIGS. 4A-4P depict a preferred sequence of operation.

FIG. 5 shows another preferred embodiment of the present invention.

FIG. 6 shows another preferred embodiment of the present invention.

FIG. 7 shows another preferred embodiment of the present invention.

FIG. 8 shows another preferred embodiment of the present invention.

FIG. 9 shows another preferred embodiment of the present invention.

FIG. 10 shows another preferred embodiment of the present invention.

FIG. 11 shows a preferred singulator.

FIG. 12 shows another preferred singulator.

FIG. 13 shows another preferred singulator.

FIG. 14 shows another preferred embodiment of the present invention.

FIG. 15 shows another preferred embodiment of the present invention.

FIG. 16 shows another preferred embodiment of the present invention.

FIG. 17 shows another preferred embodiment of the present invention.

FIG. 18 shows another preferred embodiment of the present invention.

### DETAILED DESCRIPTION OF THE PREFERRED EMBODIMENTS

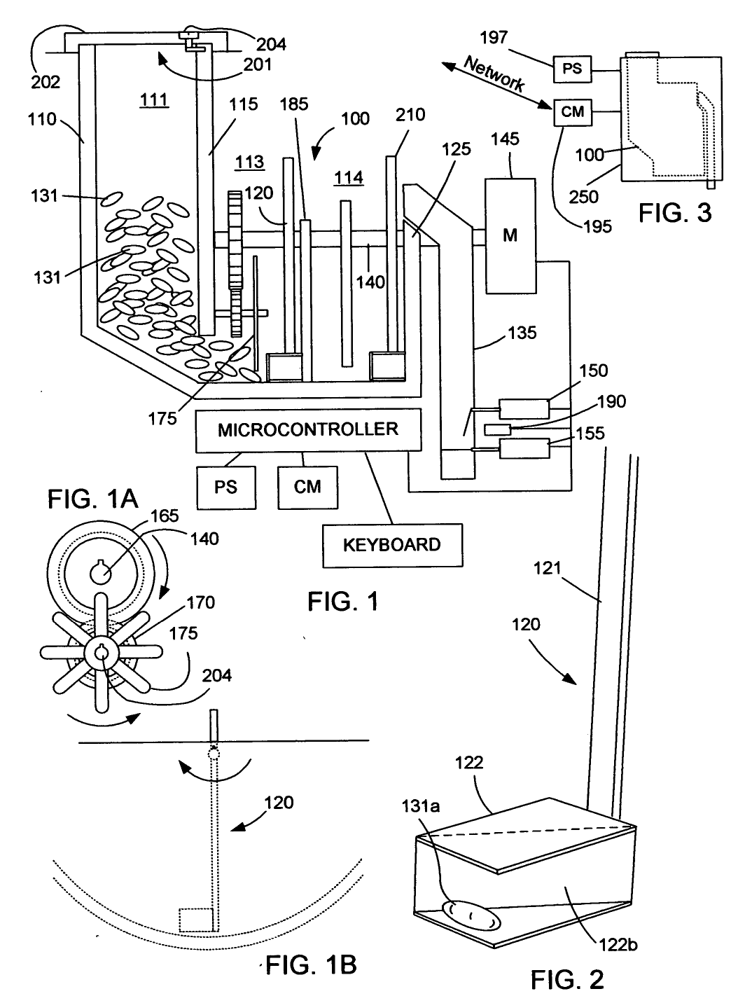

A detailed description of preferred embodiments of the present invention can be described by reference to FIGS. 1-16.

FIG. 1 shows a sectional side view of intelligent pill dispense module 100. In a preferred embodiment, pills 131 are loaded into first chamber 111 via opening 201 after first unlocking electronic lock mechanism 204 and removing lid 202. First chamber 111 is between wall 110 and wall 115. Second chamber 113 is between wall 115 and wall 185. Third chamber 114 is between wall 185 and wall 125. Main rotation shaft 140 extends through walls 125 and 185 and is supported by bearings (not shown) in walls 125, 185 and 115. Singulator 120 transfers pills 131 one by one into third chamber 114. Likewise, singulator 210 transfers pills one by one into discharge tube 135. Discharge gates 150 and 155 act together to dispense pills from discharge tube 135 so that they are accessible to the user. By utilizing three devices for singulating the pills (i.e., singulator 120, singulator 210 and discharge gates 150 and 155), the odds of inadvertently dispensing more than the desired amount of pills are greatly diminished.

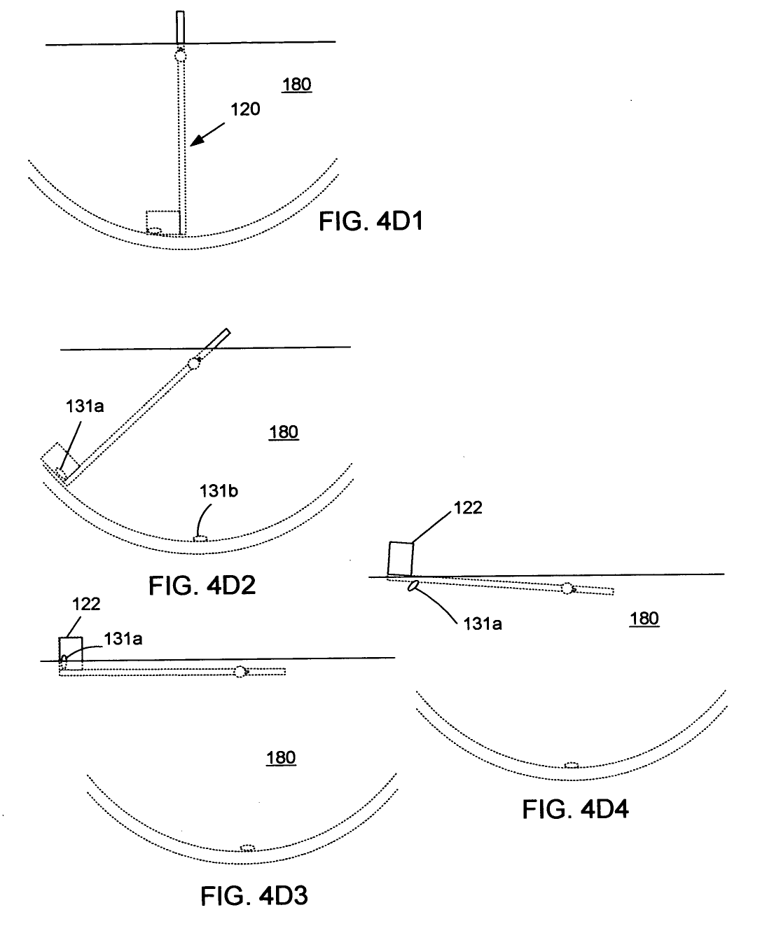

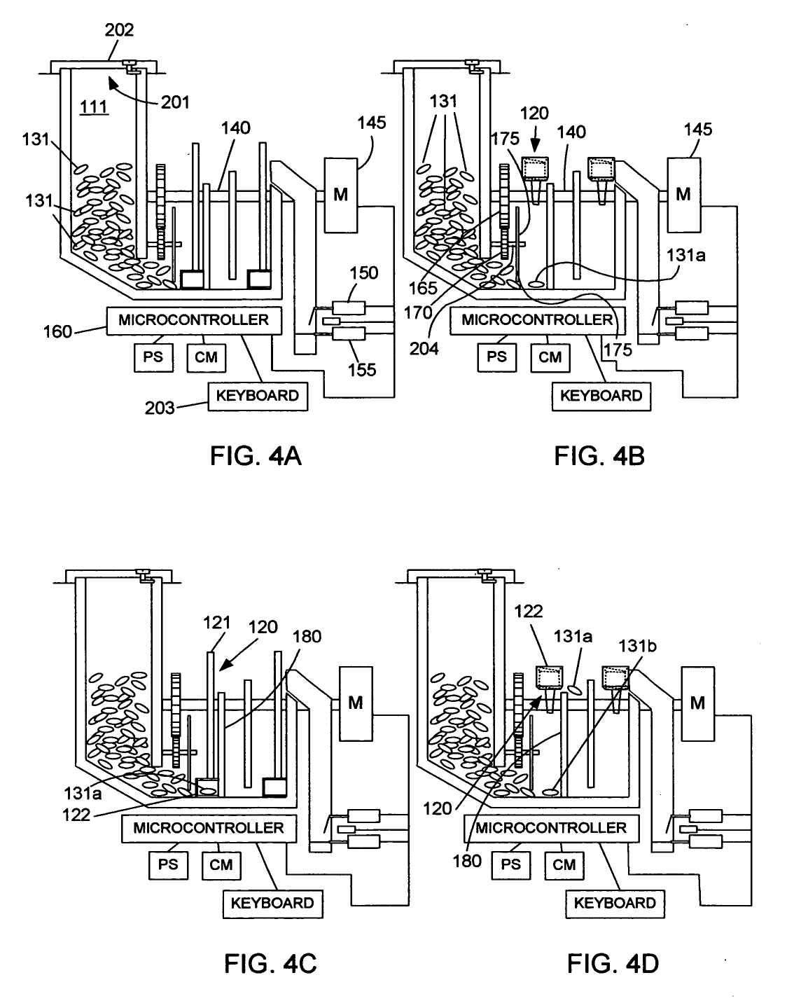

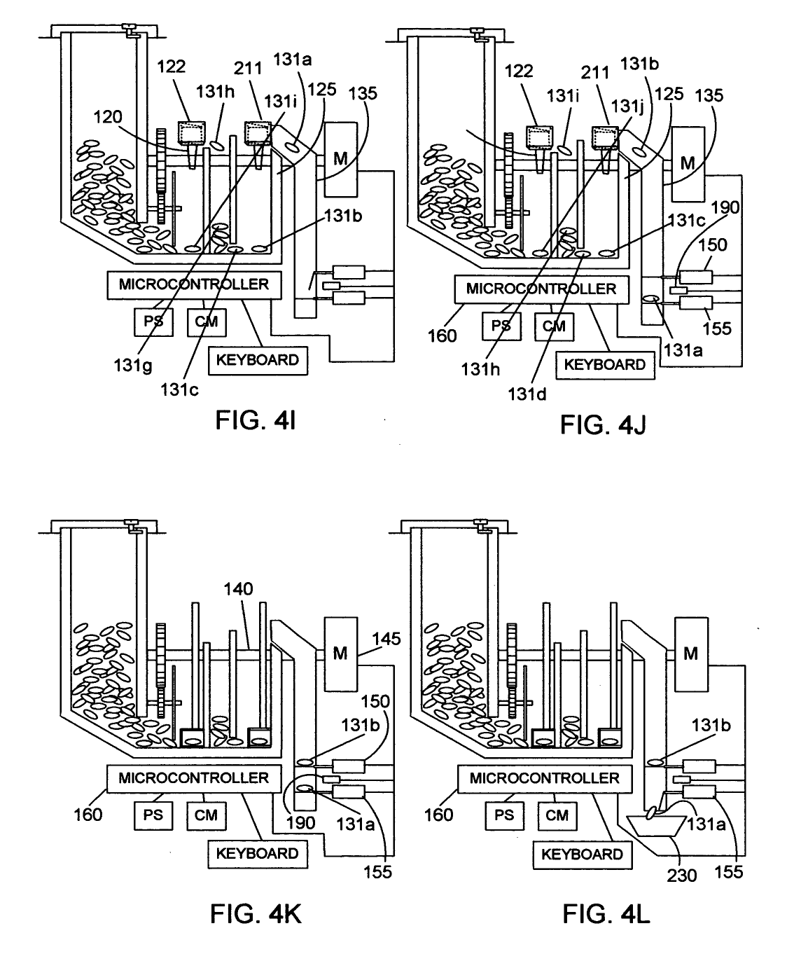

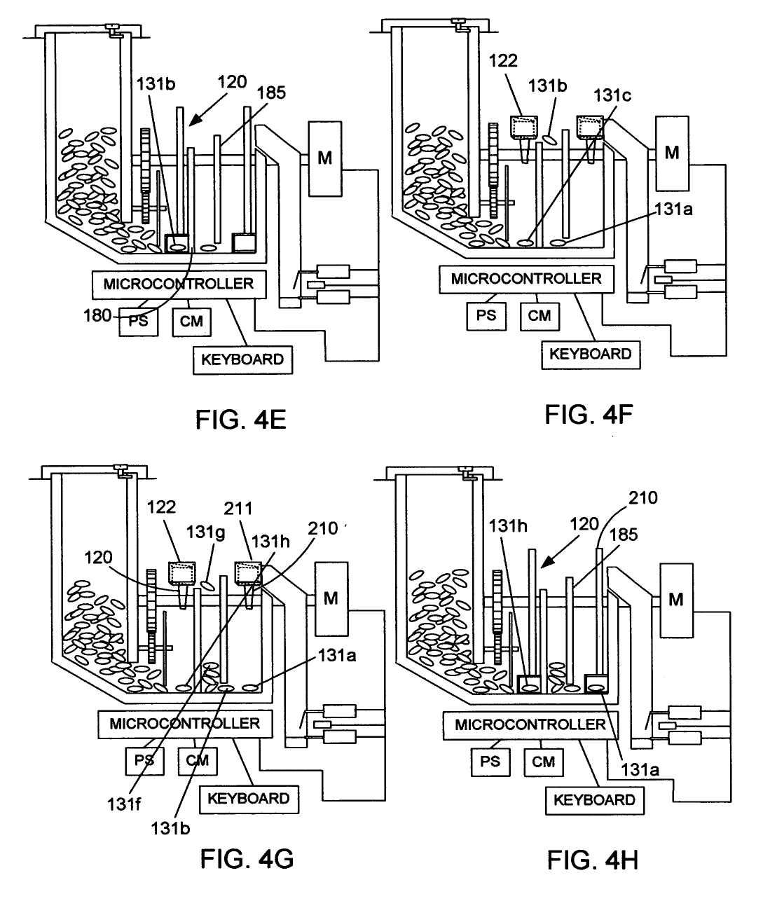

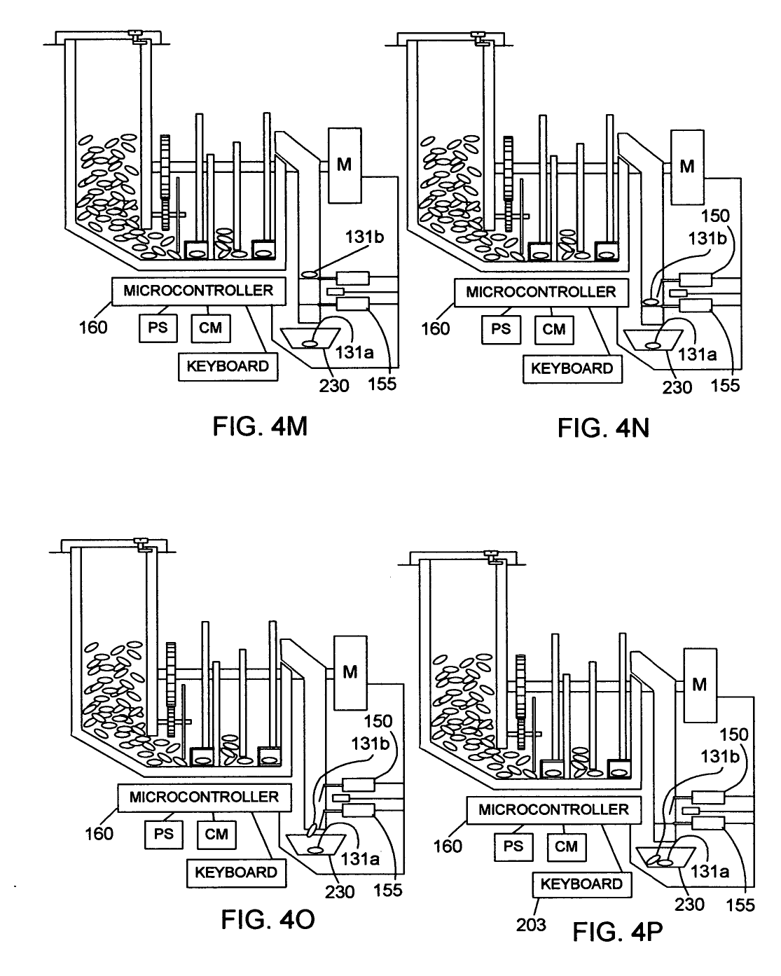

A detailed description of a sequence of operations is described below by reference to FIGS. 4A-4P.

In FIG. 4A, multiple pills 131 have been poured into first chamber 111 through opening 201. Lid 202 has then been placed on top of opening 201. An electronically releasable lock mechanism 204 secures lid 202 after pills 131 have been loaded into the chamber. Preferably, a password is required to enable the microcontroller 160 to release lock mechanism 204 when more pills are added. A user desiring two pills inputs his command for two pills into microcontroller 160 via keyboard 203. Control signals are then sent to motor 145 and discharge gates 150 and 155. Motor 145 controls the rotation of shaft 140. Also in a preferred embodiment, microcontroller 160 can be pre-programmed to dispense 1 to n pills on a schedule based upon its built-in real-time clock.

In FIG. 4B, motor 145 has rotated shaft 140 clockwise causing singulator 120 to rotate clockwise and causing agitator 175 to rotate counterclockwise. Rotation of agitator 175 assists in breaking apart pills that are jammed so that pills can move to a position under singulator 120. Clockwise rotation of singulator 120 is illustrated in FIG. 1B and counterclockwise rotation of agitator 175 is illustrated in FIG. 1A. As shown in FIG. 1A, gear 165 is pin connected to shaft 140. Gear 170 is pin connected to shaft 204. Gear 165 is meshed with gear 170. Therefore, clockwise rotation of gear 165 causes counterclockwise rotation of gear 170. Gear 170 is pin connected to shaft 204 and agitator 175 is also pin connected to shaft 204. Therefore, counterclockwise rotation of gear 170 causes counterclockwise rotation of agitator 175. Gravity, counterclockwise rotation of agitator 175 and the weight pressure from multiple pills 131 has caused pill 131a to be positioned under singulator 120, as shown in FIG. 4B.

In FIG. 4C, singulator 120 has continued its clockwise rotation and has picked up pill 131a in cup 122. A perspective view of singulator 120 is shown in FIG. 2. Cup 122 includes triangulated section 122b. As shaft 140 rotates clockwise, singulator arm 121 also rotates clockwise. As cup 122 moves clockwise, gravity forces pill 131a towards the back part of cup 122. So long as cup 122 is blocked by wall 180, wall 180 prevents pill 131a from falling out of cup 122.

In FIG. 4D, singulator 120 has rotated clockwise so that cup 122 has successfully cleared wall 180. A sequence showing a front view of cup 122 clearing wall 180 is shown in FIGS. 4D1-4D4.

In FIG. 4D1, singulator 120 is in the position shown in FIG. 4C.

In FIG. 4D2, wall 180 is preventing pill 131a from falling out of cup 122. Gravity, counterclockwise rotation of agitator 175 and the weight pressure from multiple pills 131 has caused pill 131b to be positioned under singulator 120.

In FIG. 4D3, cup 122 has rotated 90 degrees from its position in FIG. 4D1. Also, cup 122 has just begun to rise above wall 180.

In FIG. 4D4, cup 122 has risen above wall 180. With wall 180 no longer blocking pill 131a, pill 131a falls on the opposite side of wall 180, also shown in FIG. 4D.

In FIG. 4E, singulator 120 has continued its clockwise rotation and has picked up pill 131b in cup 122. Pill 131a has fallen between wall 185 and wall 180.

In FIG. 4F, cup 122 has risen above wall 180. With wall 180 no longer blocking pill 131b, pill 131a falls on the opposite side of wall 180. Pill 131c is positioned to be picked up by cup 122 on its next revolution.

In FIG. 4G, the sequence has continued through several revolutions of singulators 120 and 210. Gravity and the weight pressure from multiple pills 131b-131f have caused pill 131a to be positioned under singulator 210. Pill 131h is positioned under singulator 120.

In FIG. 4H, singulator 120 has continued its clockwise rotation and has picked up pill 131h in cup 122. Also, singulator 210 has picked up pill 131a in cup 211.

In FIG. 4I, cup 122 has risen above wall 180 and cup 211 has risen above wall 125. With wall 180 no longer blocking pill 131b, pill 131h falls on the opposite side of wall 180. Also, with wall 125 no longer blocking cup 211, pill 131a falls down Pill 131c is positioned to be picked up by cup 122 on its next revolution.

In FIG. 4J, pill 131a h a gone through discharge gate 150 and its presence has been sensed by sensor 190. Sensor 190 has sent a signal to microcontroller 160. Microcontroller 160 then sent a signal to discharge gate 150 to close. Cup 211 has dropped pill 131b down discharge tube 135.

In FIG. 4K, microcontroller 160 has sent a signal to discharge gates 150 and 155 to close. Microcontroller 160 has also sent a signal to motor 145 to stop rotating shaft 140. Pill 131a is sitting on top of discharge gate 155 and pill 131b is sitting on top of discharge gate 150.

In FIG. 4L, microcontroller 160 has sent a signal to discharge gate 155 to open. Pill 131a is falling into cup 230.

In FIG. 4M, microcontroller 160 has sent a signal to discharge gate 155 to close. Pill 131a is inside cup 230.

In FIG. 4N, microcontroller 160 has sent a signal to discharge gate 150 to open. Pill 131b is on top of discharge gate 155.

In FIG. 40, microcontroller 160 has sent a signal to discharge gate 155 to open. Pill 131b is falling into cup 230.

In FIG. 4P, microcontroller 160 has sent a signal discharge gate 155 to close. Pills 131a and 131b are both in cup 230 and easily available to the user.

If the user wants more pills, he can simply input the desired number into microcontroller 160 via keyboard 203 and the pills will be dispensed in a fashion similar to that described above in reference to FIGS. 4A-4P.

### Microcontroller and Associated Electronics

Microcontroller 160 controls motor 145, discharge gates 150 and 155, and reads sensor 190. In a preferred embodiment, microcontroller 160 also contains a unique serial number for identifying the microcontroller. Also, preferably microcontroller 160 is programmed to record the number of pills initially added, the name of the individual adding the pills, pill type, pill vendor information, pill expiration date, the control number associated with the bottle that the pills were added from, the number of pills dispensed, when they were dispensed and who requested them. Additionally, microcontroller 160 can be pre-programmed to release 1 to n pills based upon its built-in real-time clock. Also, preferably, in order for a user to be able to fill or re-fill the dispenser with pills, he must enter a catch/lock release password into the microprocessor so that the microprocessor can unlock lock mechanism 204 to release lid 202. Automatic lock mechanism 204 is to prevent unauthorized dispense of pills from the module or un-authorized fill of the module.

Preferably, module 100 is self contained in case 250 (FIG. 3). Power is provided by power supply 197. Also, in a preferred embodiment, module 100 can communicate with other control devices through a communications network via communications module 195. A preferred communications module device is a modem.

### Cost Effective

Applicant has designed the embodiment shown in FIGS. 1-4P to be inexpensive and affordable to a home user. For example, Applicant estimates the cost of the embodiment depicted in FIG. 1 to be approximately $50 in large volume manufacturing.

### Multiple Modules

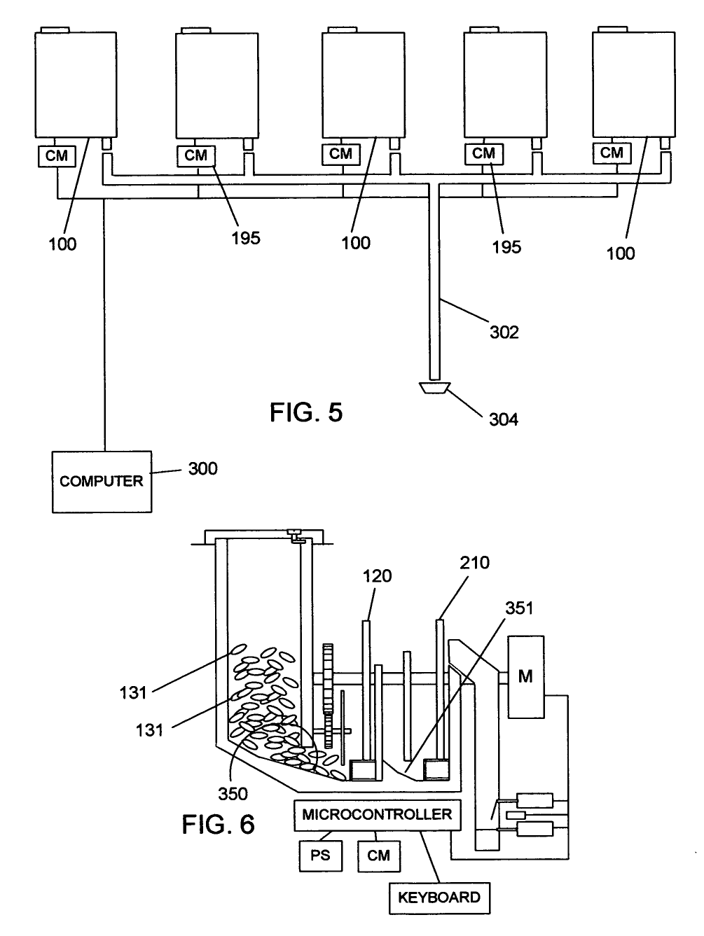

FIG. 5 shows another preferred embodiment having multiple dispense modules 100. Within each module 100 there is stored a plurality of unique pill types. For example, in a preferred embodiment, pills to control blood pressure are in a first module 100, pills to control headache pain are in a second module 100, pills to control allergies are in a third module 100, pills to control depression are in a fourth module 100, and pills to control swelling are in a fourth module 100. A user interfacing with computer 100 sends commands via communication modules 195 to the appropriate modules 100 to dispense the desired pill types and amount. The pills then are dispensed in a process similar to that described above. The dispensed pills travel down track 302 and are emptied into cup 304. The user then retrieves the dispensed pills from cup 304.

### Other Embodiments

In addition to the above described embodiments, it is clear to those skilled in the art that additional and alternative embodiments may be used to practice the present invention.

FIG. 6 shows tilted sections 350 and 351. Tilted sections 350 and 351 assist the movement of pills 131 into singulators 120 and 210, respectively.

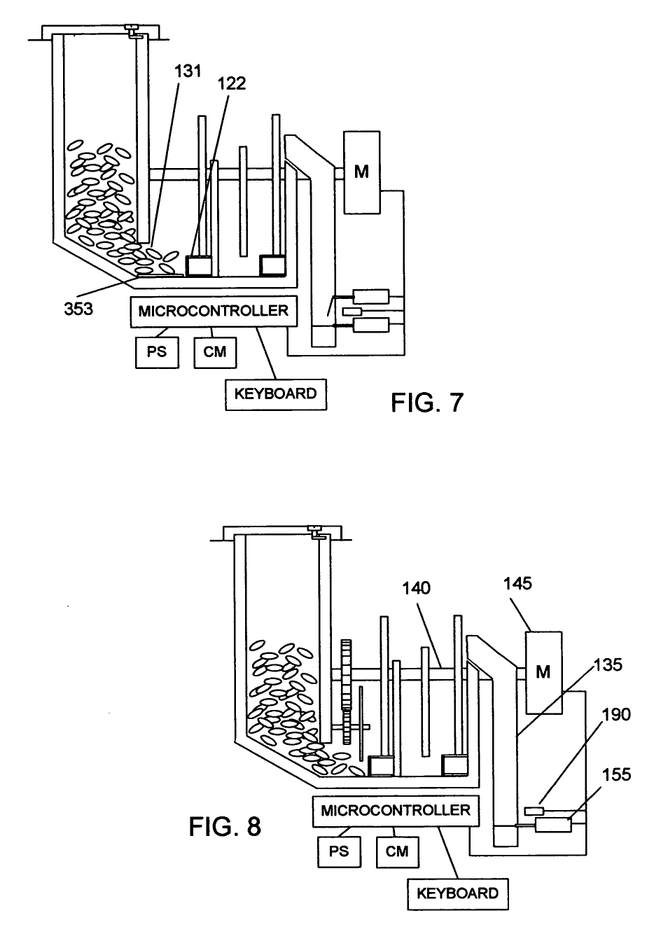

FIG. 7 shows agitator 175 (FIG. 1) replaced by vibrating mechanism 353. Vibrating Mechanism 353 shakes pills 131 so that they more easily feed into cup 122.

FIG. 8 shows that it is possible to omit discharge gate 150 and just utilize discharge gate 155 to dispense single pills through discharge tube 135. In this embodiment, when sensor 190 senses the presence of a pill on the top of discharge gate 155, it will stop motor 145 from turning shaft 140. When a pill is dispensed from discharge gate 155, motor 145 will start rotating shaft 140 until another pill is deposited on discharge gate 155.

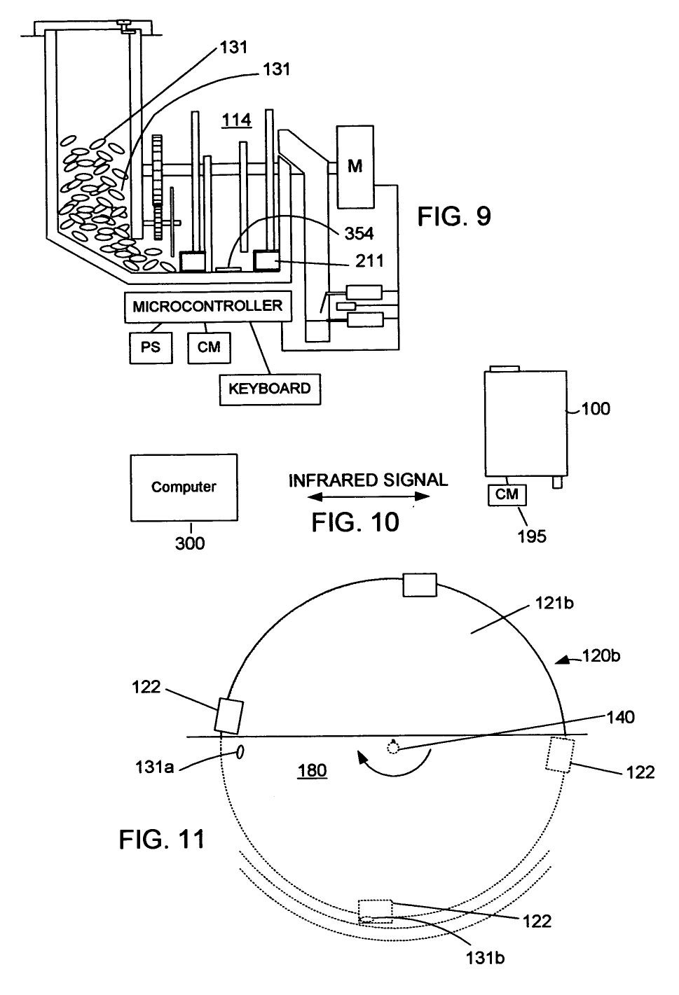

FIG. 9 shows vibrating mechanism 354 placed in third chamber 114. As with vibrating mechanism 353 (FIG. 7), vibrating mechanism 354 shakes pills 131 so that they are more easily fed into cup 211.

FIG. 10 shows user controlled computer 300 (also shown in FIG. 5) in wireless communication with dispense module 100 via communications module 195.

FIG. 11 shows singulator 120b. Singulator 120b is similar to singulator 120 (FIGS. 1 and 1B). However, singulator arm 121 has been replaced with singulator wheel 121b. In the preferred embodiment shown in FIG. 11, four cups 122 have been attached to wheel 121b. FIG. 11 shows singulator wheel 121b moving in a clockwise direction. A first cup 122 has cleared wall 180 and is dropping pill 131a behind wall 180. A second cup 122 is picking up pill 131b.

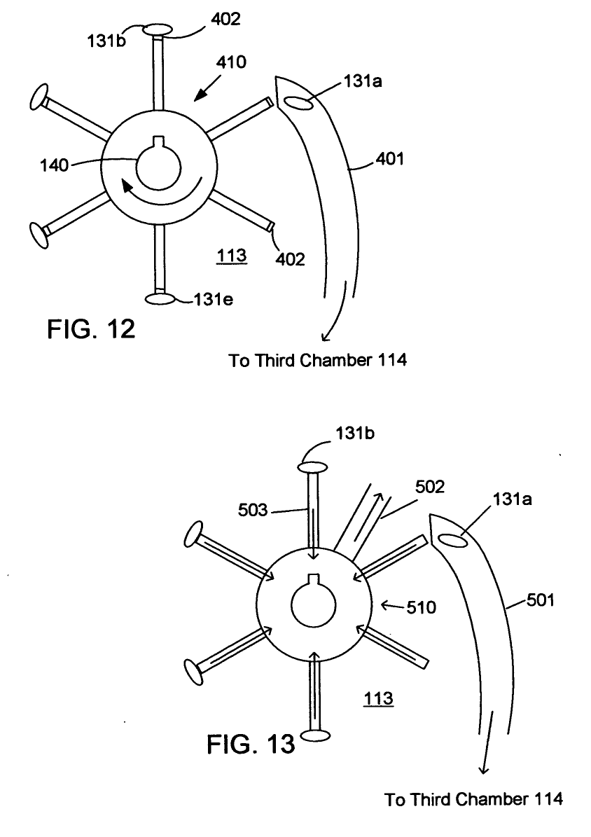

FIG. 12 shows singulator 410 attached to shaft 140. Adhesive 402 is attached to the end of each arm of singulator 410. As singulator 410 turns clockwise, adhesive 402 contacts pills located in the bottom of second chamber 113. The pills then stick to adhesive 402 while singulator 410 carries each pill to tube 401. The pills then collide with the edge of tube 401 so that the pills are knocked off the singulator arm. For example, FIG. 12 shows pill 131a being knocked of the singulator arm and being transported to third chamber 114 via tube 401.

FIG. 12 shows singulator 510 attached to shaft 140. Vacuum tube 502 provides a vacuum axially along each singulator arm of singulator 510 as indicated by the arrows. As singulator 510 turns clockwise, the singulator arms contact pills located in the bottom of second chamber 113. The pills are then drawn to the singulator arms by the vacuum. The vacuum suction of each singulator arm carries each pill to tube 501 where each pill collides with the edge of the tube so that the pills are knocked off the singulator arm. For example, FIG. 13 shows pill 131a being knocked of the singulator arm and being transported to third chamber 114 via tube 501.

FIG. 16 shows a preferred embodiment of the present invention having four chambers 701, 702, 703 and 704. Singulator 710 is in chamber 702, singulator 711 is in chamber 703, and singulator 712 is in chamber 704. As the number of chambers and singulators are increased, in becomes less likely that two pills will inadvertently be dropped down discharge tube 135 at the same time.

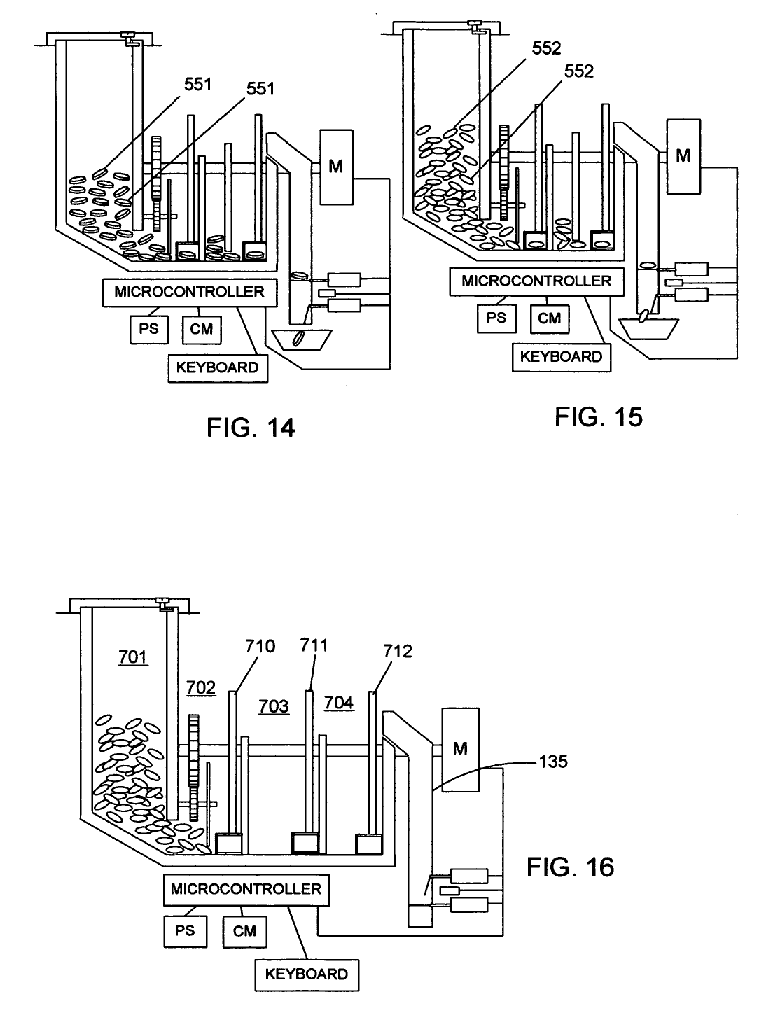

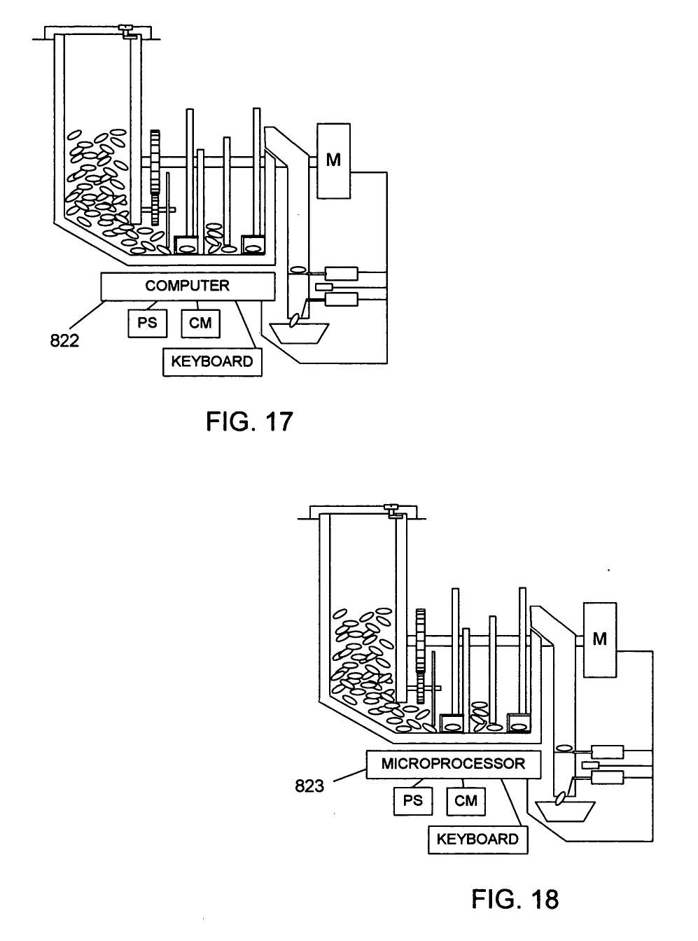

Although the above-preferred embodiments have been described with specificity, persons skilled in this art will recognize that many changes to the specific embodiments disclosed above could be made without departing from the spirit of the invention. For example, although the above preferred embodiments disclosed how the present invention could be used to dispense pills, it could likewise be used to dispense other small objects. For example, other small objects that could be dispensed included coins 551 (FIG. 14) and gemstones 552 (FIG. 15). Also, although the above embodiments disclose microcontroller 160, microcontroller 160 could be replaced with other programmable control devices. For example, FIG. 17 shows computer 822 and FIG. 18 shows microprocessor 823. Therefore, the attached claims and their legal equivalents should determine the scope of the invention.

What is claimed is:

1. A small item dispense module, comprising:
A. a first chamber for receiving and storing a plurality of small items,
B. a second chamber comprising a first singulator, wherein at least one small item from said plurality of small items is transferred from said first chamber to said second chamber,
C. a third chamber comprising a second singulator, wherein said at least one small item is transferred from said second chamber to said third chamber via said first singulator,
D. a discharge tube comprising at least one discharge gate, wherein said at least one small item is transferred from said third chamber to said discharge tube via said second singulator, wherein said at least one discharge gate controls the dispensing of said at least one small item.

2. The small item dispense module as in claim 1, wherein said plurality of small items is a plurality of pills.

3. The small item dispense module as in claim 1, wherein said plurality of small items is a plurality of coins.

4. The small item dispense module as in claim 1, wherein said plurality of small items is a plurality of gemstones.

5. The small item dispense module as in claim 1, further comprising:
A. a shaft, wherein said first singulator and said second singulator are connected to said shaft,
B. a motor for turning said shaft,
C. a microcontroller for controlling said motor and said at least one discharge gate,
D. a sensor electrically connected to said microcontroller, wherein said sensor is for sensing the presence of said at least one small item at said at least one discharge gate.

6. The small item dispense module as in claim 1, further comprising a communications module for connecting said small item dispense module to a computer network wherein said small item dispense module is controlled by a remote computer over said computer network.

7. The small item dispense module as in claim 1, further comprising an agitator for breaking loose a stack of said plurality of small items.

8. The small item dispense module as in claim 1, further comprising a vibrating mechanism for breaking loose a stack of said plurality of small items.

9. The small item dispense module as in claim 1, further comprising a cup attached to said singulators for picking up said plurality of small items.

10. The small item dispense module as in claim 1, further comprising an adhesive attached to said singulators for picking up said plurality of small items.

11. The small item dispense module as in claim 1, wherein said singulators pick up said plurality of small items by utilizing vacuum suction.

12. The small item dispense module as in claim 1, wherein said at least one discharge gate is two discharge gates.

13. The small item dispense module as in claim 1, wherein said small item dispense module is controlled by a remote computer via a wireless communication link.

14. The small item dispense module as in claim 1, further comprising:
A. a lid covering said first chamber, and
B. a lock mechanism for locking said lid.

15. The small item dispense module as in claim 14, further comprising a microcontroller for automatic control of said lock mechanism.

16. The small item dispense module as in claim 1, wherein said small items are automatically dispensed at predetermined intervals.

17. The small item dispense module as in claim 16, further comprising a microcontroller for controlling said automatic dispensing of said small items at said predetermined intervals.

18. A network of small item dispense modules, comprising:
A. A network control computer for controlling each said small item dispense module, and
B. a network dispense track for receiving small items dispensed from each said small item dispense module,
wherein each said small item dispense module comprises:
A. a first chamber for receiving and storing a plurality of small items,
B. a second chamber comprising a first singulator, wherein at least one small item from said plurality of small items is transferred from said first chamber to said second chamber,
C. a third chamber comprising a second singulator, wherein said at least one small item is transferred from said second chamber to said third chamber via said first singulator, and
D. a discharge tube comprising at least one discharge gate, wherein said at least one small item is transferred from said third chamber to said discharge tube via said second singulator, wherein said at least one discharge gate controls the dispensing of said at least one small item.

19. A small item dispense module, comprising:
A. at least three chambers for holding and transferring a plurality of small items, said at least three chambers comprising:
1. a first chamber for receiving said plurality of small items and for transferring at least one small item of said plurality of small items,
2. at least two other chambers each comprising a singulator for transferring said at least one small item,
B. a discharge tube comprising at least one discharge gate, wherein said at least one small item is transferred from one of said at least two other chambers to said discharge tube via said singulator, wherein said at least one discharge gate controls the dispensing of said at least one small item.

20. The small item dispense module as in claim 19, wherein said at least two other chambers is two chambers.

21. The small item dispense module as in claim 19, wherein said at least two other chambers is three chambers.

22. A small item dispense module, comprising:
A. a first chamber means for receiving and storing a plurality of small items,
B. a second chamber means comprising a first singulator means, wherein at least one small item from said plurality of small items is transferred from said first chamber means to said second chamber means,
C. a third chamber means comprising a second singulator, wherein said at least one small item is transferred from said second chamber to said third chamber via said first singulator,
D. a discharge tube comprising at least one discharge gate, wherein said at least one small item is transferred from said third chamber to said discharge tube via said second singulator, wherein said at least one discharge gate controls the dispensing of said at least one small item.

23. A method for dispensing small items, comprising the steps of:
A. inputting a plurality of small items into a first chamber,
B. transferring at least one small item from said plurality of small items from said first chamber to said second chamber, said second chamber comprising a first singulator,
C. utilizing said first singulator to transfer said at least one small item to a third chamber comprising a second singulator,
D. utilizing said second singulator to transfer at least one small item to a discharge tube comprising at least one discharge gate, wherein said at least one discharge gate controls the dispensing of said at least one small item.

24. A small item dispense module, comprising:
A. a first chamber for receiving and storing a plurality of small items,
B. a second chamber comprising a first singulator, wherein at least one small item from said plurality of small items is transferred from said first chamber to said second chamber,
C. a third chamber comprising a second singulator, wherein said at least one small item is transferred from said second chamber to said third chamber via said first singulator,
D. a discharge tube comprising at least one discharge gate, wherein said at least one small item is transferred from said third chamber to said discharge tube via said second singulator, wherein said at least one discharge gate controls the dispensing of said at least one small item, and
E. a computer for controlling said first singultator, said second singulator and said at least one discharge gate.

25. The small item dispense module as in claim 24, wherein said computer is a microcontroller.

26. The small item dispense module as in claim 24, wherein said computer is a microprocessor.
